(19) United States
(12) Patent Application Publication
(10) Pub. No.: US 2026/0147689 A1
(43) Pub. Date: May 28, 2026

(54) SOFTWARE BUG ANALYSIS AND RESOLUTION USING LARGE LANGUAGE MODELS

(71) Applicant: SAP SE, Walldorf (DE)

(72) Inventor: Hui Li, Shanghai (CN)

(21) Appl. No.: 18/956,248

(22) Filed: Nov. 22, 2024

(51) Int. Cl. G06F 11/3604

(52) U.S. Cl. CPC G06F 11/3616

(57) ABSTRACT

Methods, systems, and computer-readable storage media for debugging errors occurring in software and can include actions of receiving a current bug ticket (CBT) including bug data descriptive of a bug occurring within a software system, prompting a LLM using a first prompt to return a first embedding representative of at least a portion of the CBT, determining a set of candidate historical bug tickets (HBTs) using the first embedding and a set of HBT embeddings, prompting the LLM using a second prompt to return a set of similar HBTs, the second prompt generated using the set of candidate HBTs, and updating the CBT to identify one or more HBTs in the set of similar HBTs.

### BACKGROUND

Software development includes a process of debugging, in which errors in source code are identified and removed. Modern software systems have increasingly large and complicated source code, which results in an increasing number and complexity of software errors, commonly referred to as bugs, that are to be identified and resolved. In general, a bug can be described as an error in the software that results in the software not performing to expectations (to specification) up to and including a crash.

To facilitate debugging, bug tracking systems (e.g., Bugzilla, Jira) can be used to track and manage resolution of bugs. For example, a bug ticket can be generated and assigned to a programming team that is tasked with resolving the bug(s). However, and due to the complexity of modern software systems, the programming team is likely not intimately familiar with every module of the software system, including modules that might be key to resolving the bug(s). As such, significant technical resources can be expended as programming teams attempt to identify the source(s) of and resolve the bug(s), which also leads to extended time periods of software systems not properly operating, if not down altogether.

### SUMMARY

Implementations of the present disclosure are directed to debugging software. More particularly, implementations of the present disclosure are directed to a software debugging system that leverages large language models (LLMs) to process a bug ticket, identify a set of similar historical bug tickets, and provide source code to resolve a bug represented within the bug ticket.

In some implementations, actions are executed for debugging errors occurring in software and can include receiving a current bug ticket (CBT) including bug data descriptive of a bug occurring within a software system, prompting a LLM using a first prompt to return a first embedding representative of at least a portion of the CBT, determining a set of candidate historical bug tickets (HBTs) using the first embedding and a set of HBT embeddings, prompting the LLM using a second prompt to return a set of similar HBTs, the second prompt generated using the set of candidate HBTs, and updating the CBT to identify one or more HBTs in the set of similar HBTs. Other implementations of this aspect include corresponding systems, apparatus, and computer programs, configured to perform the actions of the methods, encoded on computer storage devices.

These and other implementations can each optionally include one or more of the following features: actions further include determining a location of a component of the software system associated with the bug, and updating the CBT to include the location; determining a location of a component of the software system associated with the bug includes searching source code of the software system using an error message of the CBT; determining a location of a component of the software system associated with the bug includes prompting the LLM using a third prompt to return a second embedding representative of an error message of the CBT, determining a set of candidate slices using the second embedding and a set of slice embeddings, and prompting the LLM using a fourth prompt to return a set of similar slices, the fourth prompt generated using the set of candidate slices; each slice includes a number of lines of the source code; the location includes a uniform resource locator (URL); the at least a portion of the CBT comprises a title and a description of the CBT; determining a set of candidate HBTs using the first embedding and a set of HBT embeddings includes determining a set of ticket similarity scores by comparing the first embedding to each HBT embedding in the set of HBT embeddings, and adding a HBT associate with an HBT embedding to the set of candidate HBTs in response to a respective ticket similarity score at least meeting a threshold ticket score; the set of HBT embeddings is retrieved from a HBT repository and each HBT embedding in the set of HBT embeddings is generated by the LLM; and the second prompt is generated using a prompt template that is at least partially populated with HBTs in the set of candidate HBTs to provide context for the LLM in providing the set of similar HBTs.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture of a software debugging system in accordance with implementations of the present disclosure.

FIG. 3 depicts an example process that can be executed in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to debugging software. More particularly, implementations of the present disclosure are directed to a software debugging system that leverages large language models (LLMs) to process a bug ticket, identify a set of similar historical bug tickets, and provide source code to resolve a bug represented within the bug ticket.

Implementations can include actions that are executed for debugging errors occurring in software and can include receiving a current bug ticket (CBT) including bug data descriptive of a bug occurring within a software system, prompting a LLM using a first prompt to return a first embedding representative of at least a portion of the CBT, determining a set of candidate historical bug tickets (HBTs) using the first embedding and a set of HBT embeddings, prompting the LLM using a second prompt to return a set of similar HBTs, the second prompt generated using the set of candidate HBTs, and updating the CBT to identify one or more HBTs in the set of similar HBTs.

To provide further context for implementations of the present disclosure, and as introduced above, debugging software in response to errors, commonly referred to as bugs, is a time- and resource-consuming process. For example, each bug ticket raised for a software system within a bug tracking system could be caused by a variety of reasons, such as coding errors, configuration errors, hardware/network errors, incorrect input data, and the like. Such errors can reoccur relatively frequently. Due to the complexity of modern software systems, the programming team that a bug ticket is assigned to is likely not intimately familiar with every module of the software system, including modules that might be key to resolving the bug(s).

As such, significant time and technical resources can be expended as programming teams attempt to identify the source(s) of and resolve the bug(s), which can be compounded when large volumes of error messages in error logs are to be analyzed. For example, often significant volumes of data in the error logs are parsed and analyzed to identify root causes of errors. This consumes time and computing resources (e.g., processors, memory). Once a root cause of an error is identified, a solution that appropriately mitigates the root cause must be identified and deployed. In many instances, multiple solutions are possible for a particular root cause, however, each solution is not equally effective, and a solution to one root cause, might result in errors elsewhere.

The software debugging process is even more complex, often impractical, for less experienced users, such as users that are not software developers (non-developer users) and even software developers, who did not personally develop the software in question. For example, log messages are difficult to understand for non-developer users and can also be difficult for developers that did not develop the software being debugged. Example error messages can include, for example and without limitation, program stack traces, error codes, status codes, and/or system errors (e.g., out of memory, time out events).

In view of the above context, implementations of the present disclosure provide a software debugging system that leverages a LLM for time- and resource-efficient resolution of software errors, referred to as bugs herein, represented in bug tickets. As described in further detail herein, the LLM is used to identify a set of historical bug tickets (HBTs) from a current bug ticket (CBT) that is representative of a bug that is to be resolved. In some examples, an embedding generated using the CBT is compared to embeddings generated using the HBTs to define a set of candidate HBTs. In some examples, the set of candidate HBTs is used to prompt the LLM to return a set of similar HBTs that is added to the CBT and that can be used to resolve the bug represented in the CBT.

In some implementations, the software debugging system can identify a location of source code that is relevant to the bug represented in the CBT (e.g., the source code that includes the bug). In some examples, an error message is extracted from the CBT using the LLM and is used to search source code. If source code is identified based on the error message, a location of the source code (e.g., a uniform resource locator (URL)) is added to the CBT. In some examples, if source code is not identified based on the error message, an error message embedding can be generated and be used to determine a set of candidate code slices, which can be added to the CBT and can be used to resolve the bug represented in the CBT.

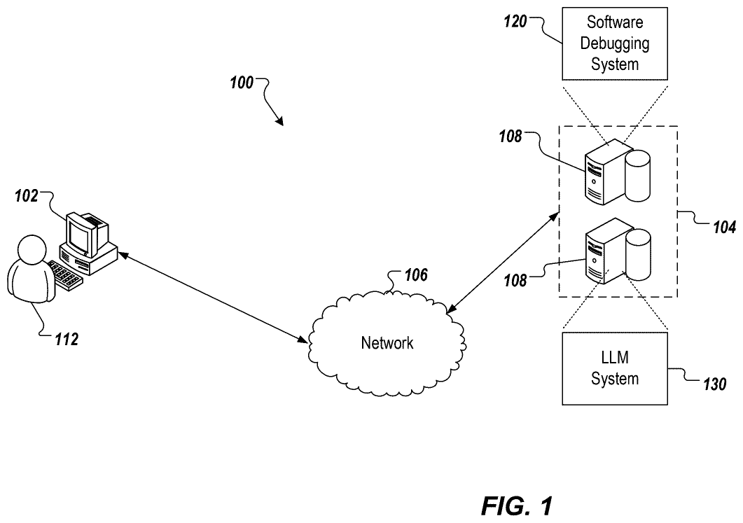

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provide services to any number of client devices (e.g., the client device 102 over the network 106).

In accordance with implementations of the present disclosure, and as noted above, the server system 104 can host a software debugging system 120 for identifying solutions for mitigating root causes to bugs and deploying solutions. For example, the user 112 (e.g., a developer tasked with resolving bugs) can interact with the software debugging system 120 through the client device 102 to resolve bugs.

As described in further detail herein, the software debugging system 120 interacts with a LLM system 130 to identify and add information to bug tickets to assist in resolution of bugs represented in the bug tickets. For example, the software debugging system 120 can process a CBT to identify a set of similar HBTs, which can be added to the CBT. In some examples, the software debugging system 120 can identify a location of source code that is relevant to the bug represented in the CBT (e.g., the source code that is a source of an error) and can add the location to the CBT. In some examples, the LLM system 130 is used to identify the set of similar HBTs. In some examples, the LLM system 130 is used to identify the location of source code. In some implementations, the LLM system 130 is a third-party system that processes prompts through a LLM. Example LLMs include, without limitation, GPT-4 and LLaMa. Implementations of the present disclosure can be realized using any appropriate LLM.

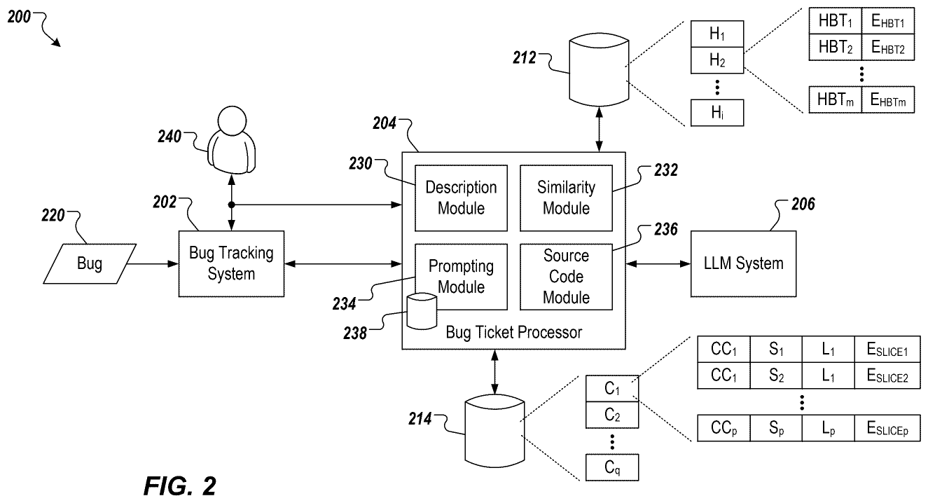

FIG. 2 depicts an example conceptual architecture 200 for debugging software in accordance with implementations of the present disclosure. In the depicted example, the conceptual architecture 200 includes a bug tracking system 202, a bug ticket processor 204, a LLM system 206 (e.g., the LLM system 130 of FIG. 1), a HBT repository 212, and a code repository 214. In some examples, the bug tracking system 202 is a third-party system (e.g., Bugzilla). In some examples, the software debugging system (e.g., the software debugging system 120 of FIG. 1) of the present disclosure includes the bug ticket processor 204. In some examples, the software debugging system of the present disclosure includes the bug tracking system 202 and the bug ticket processor 204. For example, the bug ticket processor 204 can be integrated within or be an add-on to the bug tracking system 202. In some examples, the bug ticket processor 204 includes a description module 230, a similarity module 232, a prompting module 234, and a source code module 236. In some examples, the prompting module 234 accesses a prompt template repository 238, as described in further detail herein.

In some implementations, a bug can arise in execution of software and can result in bug data 220 being submitted to the bug tracking system 202. For example, in response to a bug, the bug data 220 can be automatically generated (e.g., by the software and/or a system within which the software executes) and transmitted to the bug tracking system 202. In response to the bug data 220, the bug tracking system 202 generates a bug ticket, such as a CBT. As used herein, a CBT is a bug ticket that represents a bug that is to be resolved (a bug that is pending resolution). For purposes of non-limiting illustration and discussion, an example CBT can be provided as:

| | |
|---|---|
| ID | BUG-12345 |
| Title | Can't show orders on the order history page |
| Product | E-Commerce |
| Description | When opening the page order−>order history, |
| | the page shows the error: Can't query order |
| | due to NullPointer. |
| Create Date | 2024-01-28 13:30:45 |
| Status | NEW |
| Resolve Date | |
| Resolve Pull | |
| Request | |
| Comments | |

### Example CBT

In some examples, in response to the bug, a user 240 (e.g., a developer) is assigned responsibility for resolving the bug represented in the CBT.

In some implementations, the CBT is processed through the bug ticket processor 204 to identify and add information to the CBT to assist in resolution of the bug represented in the CBT. In some examples, information can include a set of similar HBTs that is determined based on the CBT. In some examples, information can include location of source code that is determined based on the CBT.

In further detail, the CBT is processed by the bug ticket processor 204 to identify a set of similar HBTs. In some examples, a CBT embedding is generated for the CBT, which can be denoted as E_{CBT}. In general, an embedding can be described as a multi-dimensional, floating-point vector (e.g., an N-dimensional vector) that represents an entity (e.g., a CBT). In some examples, a title and a description of the CBT are combined (e.g., concatenated) and the combined title-description is processed to provide E_{CBT}. For example, the description module 230 can combine the title and the description to provide the combined title-description, and the prompting module 234 can prompt the LLM system 206 to return E_{CBT} for the combined title-description. In some examples, the prompting module 234 uses a bug ticket (BT) embedding prompt template that is stored in the prompt template repository 238 to generate a BT embedding prompt (e.g., by populating a placeholder of the BT embedding prompt template with the combined title-description) and prompts the LLM system 206 using the BT embedding prompt, which returns E_{CBT} in response to the BT embedding prompt.

In some implementations, a set of candidate HBTs is determined by comparing the CBT to HBTs stored in the HBT repository 212. For example, the HBT repository 212 stores HBTs representing bugs that have been resolved (historical bugs). In some examples, the HBT repository 212 stores multiple sets of HBTs, each set of HBTs corresponding to a respective product (e.g., software product, such as E-Commerce in the Example CBT, above). For example, a set of products {1, . . . , i} can be provided and the HBT repository 212 stores sets of HBTs [symbol] , . . . , [symbol] .

Each HBT is stored with a corresponding HBT embedding, which can be denoted as E_{HBT}. For example, for each set of HBTs (e.g., H₂={HBT₁, . . . , HBTₘ}) a set of HBT embeddings (e.g., {E_{HBT1}, . . . , E_{HBTm}}) can be provided. In some examples, each E_{HBT} is provided by combining the title and the description of the respective HBT to provide a combined title-description that is used to prompt the LLM system 206. In some examples, the prompting module 234 uses the BT embedding prompt template that is stored in the prompt template repository 238 to generate a BT embedding prompt (e.g., by populating a placeholder of the BT embedding prompt template with the combined title-description) and prompts the LLM system 206 using the BT embedding prompt, which returns E_{HBT} for the respective HBT in response to the BT embedding prompt.

In some implementations, the CBT is compared to each HBT in a set of HBTs stored in the HBT repository 212. In some examples, a set of HBTs is selected for comparison based on the product identified in the CBT. For example, the set of HBTs [symbol] can be selected for the product E-Commerce of the Example CBT, above, and can include a set of HBT embeddings {E_{HBT1}, . . . , E_{HBTm}}. In some examples, E_{CBT} is compared to each of {E_{HBT1}, . . . , E_{HBTm}} and a set of ticket similarity scores (e.g., {c_{T1}, . . . , c_{Tm}}) is generated, each ticket similarity score representing a degree of similarity between the CBT and a respective HBT. In some examples, the ticket similarity scores are calculated (e.g., by the similarity module 232) as a cosine correlation coefficient between E_{CBT} and a respective E_{HBT} using the following example relationship:

$${c}_{Ti} = \frac{{\sum }_{n = 1}^{N} ( {E}_{CBT , n} \cdot {E}_{HBTi , n} )}{\sqrt{{\sum }_{n = 1}^{N} {( {E}_{CBT , n} )}^{2}} \cdot \sqrt{{\sum }_{n = 1}^{N} {( {E}_{HBTi , n} )}^{2}}}$$

where N is the dimension of the embeddings, E_{CBT,n} is the n^{th} element of E_{CBT}, E_{HBTi,n} is the n^{th} element of E_{HBTi}, and E_{HBTi} is the ith E_{HBT} in the set of HBT embeddings being compared.

In some implementations, each ticket similarity score is compared to a threshold ticket similarity score (c_{TTHR}). In some examples, if a ticket similarity score meets or exceeds the threshold ticket similarity score, the HBT corresponding to the ticket similarity score is added to a set of candidate HBTs. By way of non-limiting example, E_{CBT} can be compared to E_{HBT2} to provide c_{T2}, and it can be determined that c_{T2} meets or exceeds c_{TTHR}. Consequently, HBT₂ can be added to the set of candidate HBTs. In some implementations, a top X (e.g., top 5) ticket similarity scores can be determined and the HBTs corresponding to the top X ticket similarity scores can be added to the set of candidate HBTs.

In some implementations, if the set of candidate HBTs is non-empty (i.e., includes one or more HBTs), a set of similar HBTs is determined by prompting the LLM system 206. In some examples, the prompting module 234 generates a similar HBT prompt using a similar HBT prompt template retrieved from the prompt template repository 238. An example similar HBT prompt template can be provided as:
You are a software expert. A new ticket is created as follows:
′″
{description of new ticket}
′″
There are some old candidate tickets:
′″
{description of candidate tickets}
′″
Please return the qualified old candidate tickets that have a similar description as the new ticket. Just return the serial numbers of the tickets. For example, if candidate tickets {selected tickets} meet the requirement, please return the following:
′″
{example answer}
′″
If no candidate ticket matches the requirement, please do not try to answer this question, just return none.

### Example Similar HBT Prompt Template

Here, brackets { } indicate placeholders that are populated to generate the similar HBT prompt. An example similar HBT prompt can be provided as:
You are a software expert. A new ticket is created as follows:
′″
//description of new ticket
′″
There are some old candidate tickets:
′″
(BUG-1111). <description of candidate ticket BUG-1111>
(BUG-1112). <description of candidate ticket BUG-1112>
(BUG-1113). <description of candidate ticket BUG-1113>
′″
Please return the qualified old candidate tickets that have a similar description as the new ticket. Just return the serial numbers of the tickets. For example, if candidate tickets BUG-1112, BUG-1113 meet the requirement, please return the following:
′″
BUG-1112, BUG-1113
′″
If no candidate ticket matches the requirement, please do not try to answer this question, just return none.

### Example Similar HBT Prompt Template

Here, //description of new ticket is the description provided in the CBT (e.g., “When opening the page order->order history, the page shows the error: Can't query order due to NullPointer.” of the Example CBT, above).

In some implementations, if the LLM system 206 returns a non-empty set of similar HBTs (i.e., includes one or more HBTs), the CBT is updated to provide an updated CBT. In some examples, the CBT is updated to include HBTs in the set of similar HBTs. Continuing with the non-limiting, example CBT above, an example updated CBT can be provided as:

| | |
|---|---|
| ID | BUG-12345 |
| Title | Can't show orders on the order history page |
| Product | E-Commerce |
| Description | When opening the page order−>order history, |
| | the page shows the error: Can't query order |
| | due to NullPointer. |
| Create Date | 2024-01-28 13:30:45 |
| Status | NEW |
| Resolve Date | |
| Resolve Pull | |
| Request | |
| Comments | |
| Similar | BUG-1112 Can't open order history page |
| Historical | BUG-1113 Error in the order history page |
| Ticket | BUG-1211 Error in production page |

### Example Updated CBT

In some examples, the updated CBT enables the user 240 to more time- and resource-efficiently resolve the bug represented in the CBT. For example, the user 240 can reference HBTs identified in the updated CBT to identify resolutions to historical bugs that can be effective in resolving the current bug.

In order to further improve time- and resource-efficiency of resolving the bug represented in the CBT, the bug ticket processor 204 can identify location(s) of source code that can be the source of the bug (i.e., the code that the error(s) originated from). In some implementations, if the CBT (or updated CBT) includes an error message, the error message can be used to determine the location of the code. In some implementations, the LLM is used to extract the error message. An example prompt to exact error message can be provided as:
You are a software expert. A bug ticket is created as follows:
′″
//description of ticket
′″
Please extract the error message that is showed from the software system. For example, if the ticket content is:
′″
When opening the page order->order history, the page shows the error: Can't query order due to NullPointer.
′″
The error message is as the following:
′″
Can't query order due to NullPointer
′″
You can just return the result. If there is no error message in the ticket, please do not try to answer this question, just return none.

### Example Prompt Template to Extract Error Message

Here,//description of ticket is the description provided in the CBT. The LLM will return the error message directly if it exists.

In further detail, the source code module 236 can use the error message to search source code and locations of code. In some examples, searching the source code can include matching the error message to text of the source code to determine any matches within code components (e.g., class, method). In some examples, syntactic search is used, in which a string search is used to search a codebase, within which code is stored. For example, and considering the example above, the string “Can't query order due to NullPointer” can be used search to search the codebase. If a match exists, a location (e.g., URL) of the code component within a source code repository can be returned. Continuing with the non-limiting example above, an example error message can include “Can't query order due to NullPointer,” which can be used to identify code components. For purposes of non-limiting illustration, the following example code component can be considered:

Listing 1: Example Code Component

```
class DBService{
  List<T> query(String sql, Class<T> clazz){
    try{
      return dao.query(sql, clazz)
    } catch(Exception ex){
      throw new InternalException(String.format( “Can't query order
due to NullPointer”, clazz.getName( ), ex.getMessage( )));
    }
      }
}
```

In this example, a location (URL) of the code component of Listing 1 would be returned, because the error message is found in the code component. If a location is returned, the CBT can be (again) updated to include the location. Continuing with the non-limiting, example CBT above, an example updated CBT can be provided as:

| | |
|---|---|
| ID | BUG-12345 |
| Title | Can't show orders on the order history page |
| Product | E-Commerce |
| Description | When opening the page order−>order history, |
| | the page shows the error: Can't query order |
| | due to NullPointer. |
| Create Date | 2024-01-28 13:30:45 |
| Status | NEW |
| Resolve Date | |
| Resolve Pull | |
| Request | |
| Comments | |
| Similar | BUG-1112 Can't open order history page |
| Historical | BUG-1113 Error in the order history page |
| Ticket | BUG-1211 Error in production page |
| Source Code | https://domain/project/src/com/package/ |
| Location | DBService.java#L122 |
| | https://domain/project/src/com/pachage/ |
| | Dummy.java#L456 |

### Example Updated CBT

For purposes of another non-limiting illustration, the following example code component can be considered:

Listing 2: Example Code Component

```
class DBService{
  List<T> query(String sql, Class<T> clazz){
    try{
      return dao.query(sql, clazz)
    } catch(Exception ex){
      throw new InternalException(String.format( “Can't %s order
due to %s”, clazz.getName( ), ex.getMessage( )));
    }
      }
}
```

In this example, a location (URL) of the code component of Listing 2 would not be returned, because the error message is not found in the code component (there is not a precise match). In some implementations, if the error message cannot be matched to any source code components (as in the non-limiting example based on Listing 2), the LLM system 206 can be leveraged to locate source code based on a semantic search.

In further detail, source code of any software that is to be debugged using the software debugging system of the present disclosure can be split into multiple sets of slices, each set of slices corresponding to a respective product (e.g., E-Commerce in the Example CBT, above), and each slice containing several lines of code. In some examples, the number of lines of code in each slice can be a parameter that is configured. In some examples, each set of slices is stored in the code repository 214 for each product (e.g., E-Commerce in the Example CBT, above), each slice in a set of slices is stored in the code repository 214 with the code component (e.g., class) that the slice is found within, and a location (e.g., URL) of the code component. In some examples, each slice is uniquely identified by a slice serial number that is assigned thereto.

In some implementations, for each slice, a slice embedding (E_{SLICE}) is generated using the LLM system 206 and is stored in the code repository 214. For example, for a product C₁ (e.g., E-Commerce), a code component CC₁ (e.g., package.DBService) can be at a location L₁ (e.g., https://domain/project/src/com/package/DBService.java#L122) and can be sliced into slices S₁ and S₂, for which, slice embeddings E_{SLICE1} and E_{SLICE2} can be respectively generated. For example, S₁ can be provided as:

Listing 3: Example Slice of Listing 1

```
  try{
    return dao.query(sql, clazz)
  } catch(Exception ex){
    throw new InternalException(String.format( “Can't %s order
due to %s”, clazz.getName( ), ex.getMessage( )));
  }
```

In some examples, each slice S is used to prompt the LLM system 206. In some examples, the prompting module 234 uses a slice embedding prompt template that is stored in the prompt template repository 238 to generate a slice embedding prompt (e.g., by populating a placeholder of the slice embedding prompt template with the slice S) and prompts the LLM system 206 using the slice embedding prompt, which returns E_{SLICE} for the respective slice S in response to the slice embedding prompt.

In some implementations, an error message embedding E_{EM} is generated for the error message of the CBT (or the updated CBT). For example, the prompting module 234 can prompt the LLM system 206 to return E_{EM} for the error message. In some examples, the prompting module 234 uses an error message embedding prompt template that is stored in the prompt template repository 238 to generate an error message embedding prompt (e.g., by populating a placeholder of the error message embedding prompt template with the error message) and prompts the LLM system 206 using the error message embedding prompt, which returns E_{EM} in response to the embedding prompt.

In some implementations, the error message is compared to each slice stored in the code repository 214. In some examples, E_{EM} is compared to each of {E_{SLICE1}, . . . , E_{SLICEp}} and a set of slice similarity scores (e.g., {c_{S1}, . . . , c_{Sp}}) is generated, each slice similarity score representing a degree of similarity between the error message and a respective slice. In some examples, the slice similarity scores are calculated (e.g., by the similarity module 232) as a cosine correlation coefficient between E_{EM} and a respective E_{SLICE} using the following example relationship:

$${c}_{Si} = \frac{{\sum }_{n = 1}^{N} ( {E}_{EM , n} \cdot {E}_{SLICEi , n} )}{\sqrt{{\sum }_{n = 1}^{N} {( {E}_{EM , n} )}^{2}} \cdot \sqrt{{\sum }_{n = 1}^{N} {( {E}_{SLICEi , n} )}^{2}}}$$

where N is the dimension of the embeddings, E_{EM,n} is the n^{th} element of E_{EM}, E_{SLICEi,n} is the n^{th} element of E_{SLICEi}, and E_{SLICEi} is the ith E_{SLICE} in the set of slice embeddings being compared.

In some implementations, each slice similarity score is compared to a threshold slice similarity score (c_{STHR}). In some examples, if a slice similarity score meets or exceeds the threshold slice similarity score, the slice corresponding to the slice similarity score is added to a set of candidate slices. By way of non-limiting example, E_{EM} can be compared to E_{SLICE1} to provide c_{S1}, and it can be determined that c_{S1} meets or exceeds c_{STHR}. Consequently, S₁ can be added to the set of candidate slices. In some implementations, a top X (e.g., top 5) slice similarity scores can be determined and the slices corresponding to the top X slice similarity scores can be added to the set of candidate slices.

In some implementations, if the set of candidate slices is non-empty (i.e., includes one or more slices), a set of similar slices is determined by prompting the LLM system 206. In some examples, the prompting module 234 generates a similar slice prompt using a similar slice prompt template retrieved from the prompt template repository 238. An example similar slice prompt template can be provided as:
You are a software expert. Some error message is thrown from the software system:
′″
{error message}
′″
There are some candidate code slices:
′″
{description of candidate code slices}
′″
Please return the qualified code slices that may throw the above error message. Just return the serial numbers of the code slices. For example, if candidate slices {selected slices} meet the requirement, please return the following:
′″
{example answer}
′″
If no candidate code slice matches the requirement, please do not try to answer this question, just return none.

### Example Similar Slice Prompt Template

Here, brackets { } indicate placeholders that are populated to generate the similar slice prompt. An example similar slice prompt can be provided as:
You are a software expert. Some error message is thrown from the software system:
′″
//error message
′″
There are some candidate code slices:
′″
(1). <code slice 1>
(2). <code slice 2>
(3). <code slice 3>
//more code slices
′″
Please return the qualified code slices that may throw the above error message. Just return the serial numbers of the code slices. For example, if candidate slices (2), (3) meet the requirement, please return the following:
′″
(2), (3)
′″
If no candidate code slice matches the requirement, please do not try to answer this question, just return none.

### Example Similar Slice Prompt

Here, //error message is the error message provided in the CBT (e.g., “Can't query order due to NullPointer” of the Example CBT, above).

In some implementations, if the LLM system 206 returns a non-empty set of slice serial numbers (i.e., includes one or more slice serial numbers), the CBT is updated to provide an updated CBT. In some examples, the CBT is updated to include the location(s) of code component(s) that include the slice(s) indicated in the set of slice serial numbers. Continuing with the non-limiting, example CBT above, an example updated CBT can be provided as:

| | |
|---|---|
| ID | BUG-12345 |
| Title | Can't show orders on the order history page |
| Product | E-Commerce |
| Description | When opening the page order−>order history, |
| | the page shows the error: Can't query order |
| | due to NullPointer. |
| | The error blocks all the processes. |
| Create Date | 2024-01-28 13:30:45 |
| Status | NEW |
| Resolve Date | |
| Resolve Pull | |
| Request | |
| Comments | |
| Similar | BUG-1112 Can't open order history page |
| Historical | BUG-1113 Error in the order history page |
| Ticket | BUG-1211 Error in production page |
| Source Code | https://domain/project/src/com/package/ |
| Location | DBService.java#L122 |
| | https://domain/project/src/com/pachage/ |
| | Dummy.java#L456 |

### Example Updated CBT

In some examples, the updated CBT enables the user 240 to more time- and resource-efficiently resolve the bug represented in the CBT. For example, the user 240 can reference the code components identified in the updated CBT to identify resolutions to historical bugs that can be effective in resolving the current bug.

As described herein, implementations of the present disclosure use syntactic search and semantic search. Syntactic search is relatively simple and efficient in terms of technical resources consumed, and the results of syntactic search are accurate. Semantic search is more complex and less precise, but is used to provide search results in instances where, for example, syntactic searches does not return results.

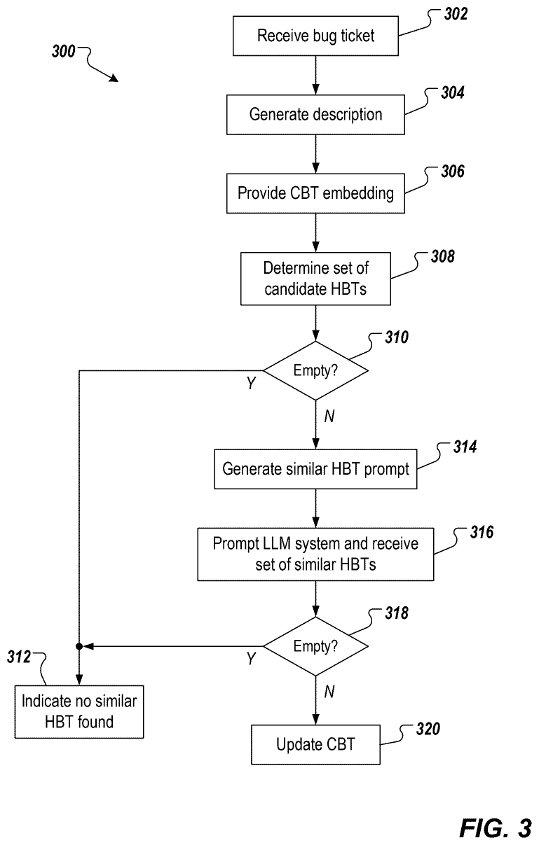

FIG. 3 depicts an example process 300 that can be executed in accordance with implementations of the present disclosure. In some examples, the example process 300 is provided using one or more computer-executable programs executed by one or more computing devices.

A bug ticket is received (302). For example, and as described in detail herein, in response to a bug, the bug data 220 can be automatically generated (e.g., by the software and/or a system within which the software executes) and transmitted to the bug tracking system 202. In response to the bug data 220, the bug tracking system 202 generates a bug ticket, such as a CBT. The CBR can be received by the description module 230. A description is generated (304). For example, and as described in detail herein, a title and a description of the CBT are combined to provide a combined title-description. A CBT embedding is provided (306). For example, and as described in detail herein, a CBT embedding is generated for the CBT, which can be denoted as E_{CBT}, by prompting the LLM system 206 to return E_{CBT} for the combined title-description.

A set of candidate HBTs is determined (308). For example, and as described in detail herein, the CBT is compared to each HBT in a set of HBTs stored in the HBT repository 212. For example, E_{CBT} is compared to each of {E_{HBT}1, . . . , E_{HBTm}} and a set of ticket similarity scores (e.g., {c_{T1}, . . . , c_{Tm}}) is generated, each ticket similarity score representing a degree of similarity between the CBT and a respective HBT. Each ticket similarity score is compared to a threshold ticket similarity score (c_{TTHR}). In some examples, if a ticket similarity score meets or exceeds the threshold ticket similarity score, the HBT corresponding to the ticket similarity score is added to a set of candidate HBTs. It is determined whether the set of candidate HBTs is empty (310). If the set of candidate HBTs is empty, an indication is provided that no similar HBT has been found (312). For example, the user 240 can receive a notification (e.g., from the bug tracking system 202) that no similar HBT has been found.

If the set of candidate HBTs is not empty, a similar HBT prompt is generated (314) and the LLM system is prompted and a set of similar HBTs is received (316). For example, and as described in detail herein, the prompting module 234 generates a similar HBT prompt using a similar HBT prompt template retrieved from the prompt template repository 238, which is used to prompt the LLM system 206. The LLM system returns a set of similar HBTs. It is determined whether the set of similar HBTs is empty (310). If the set of similar HBTs is empty, an indication is provided that no similar HBT has been found (312). For example, the user 240 can receive a notification (e.g., from the bug tracking system 202) that no similar HBT has been found. If the set of similar HBTs is not empty, the CBT is updated (320). For example, and as described herein, the CBT is updated to identify the HBTs in the set of similar HBTs.

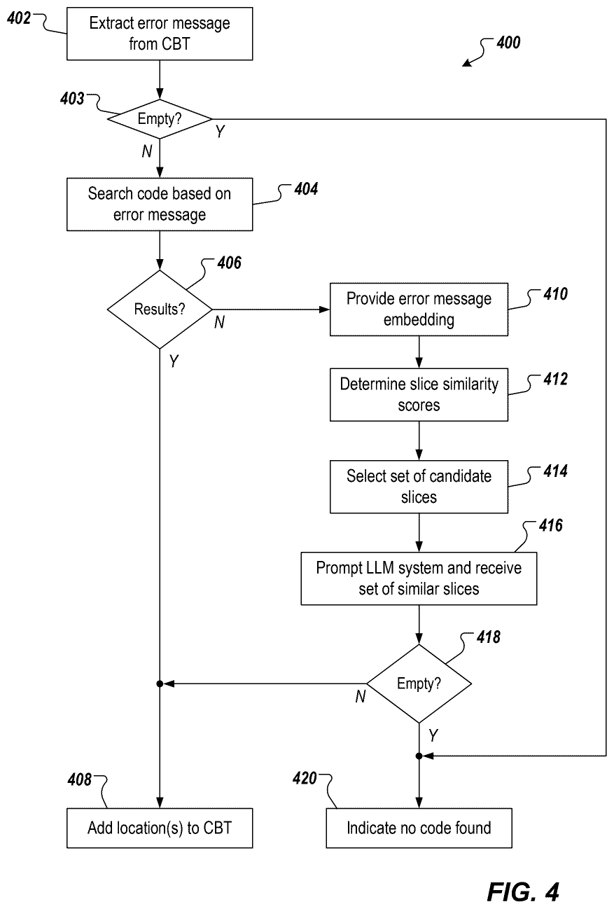

FIG. 4 depicts an example process 400 that can be executed in accordance with implementations of the present disclosure. In some examples, the example process 400 is provided using one or more computer-executable programs executed by one or more computing devices.

An error message is extracted from the CBT (402). For example, and as described in detail herein, the prompting module 234 can prompt the LLM system 206 to extract an error message from the CBT. It is determined whether a result returned from the LLM system is empty (403). If the result is empty (i.e., an error message cannot be extracted from the CBT), an indication is provided that no code has been found (420). If the result is not empty (i.e., includes an error message extracted from the CBT), source code is searched based on the error message (404). For example, and as described in detail herein, the source code module 236 can use the error message to search source code and locations of code. In some examples, searching the source code can include matching the error message to text of the source code to determine any matches within code components (e.g., class, method). It is determined whether any results are returned from the search (406). If results are returned, one or more locations are added to the CBT (408). For example, and as described herein,

If no results are returned, an error message embedding is provided (410). For example, and as described herein, the prompting module 234 can prompt the LLM system 206 to return E_{EM} for the error message. Slice similarity scores are determined (412) and a set of candidate slices is selected (414). For example, and as described herein, E_{EM} is compared to each of {E_{SLICE1}, . . . , E_{SLICEp}} and a set of slice similarity scores (e.g., {c_{S1}, . . . , c_{Sp}}) is generated, each slice similarity score representing a degree of similarity between the error message and a respective slice. Each slice similarity score is compared to a threshold slice similarity score (c_{STHR}) and, if a slice similarity score meets or exceeds the threshold slice similarity score, the slice corresponding to the slice similarity score is added to a set of candidate slices.

The LLM system is prompted and a set of similar slices is received (416). For example, and as described herein, a set of similar slices is determined by prompting the LLM system 206. It is determined whether the set of similar slices is empty (418). If the set of similar slices is empty, an indication is provided that no code has been found (420). For example, the user 240 can receive a notification (e.g., from the bug tracking system 202) that no code has been found. If the set of similar slices is not empty, the CBT is updated (408). For example, and as described herein, the CBT is updated to include location(s) of code.

Implementations of the present disclosure achieve multiple technical improvements. For example, the software debugging system of the present disclosure enables time- and resource-efficient debugging of software systems. As described herein, the software debugging system of the present disclosure leverages a LLM solutions and an entity matching model (e.g., a GLIM model) to time- and resource-efficiently provide solutions to errors (bugs) occurring in applications and locating sources of the errors. The software debugging system enables non-expert users to (e.g., without the deep technical background/expertise) to seamlessly and efficiently troubleshoot error in applications. Time- and resource-efficiencies can be achieved, for example, using embeddings, which are contextual representations of bug tickets and error messages. As described herein, the embeddings are provided using a LLM, which obviates the need to develop and train a specific, dedicated ML models to generate embeddings. Further, the use of embeddings enables time- and resource-efficient searching for historical solutions that recorded in HBTs. In addition to the matching of errors, new novel solutions to the errors can be obtained from the LLM through prompts that capture the context of the problem like the past solutions to similar errors.

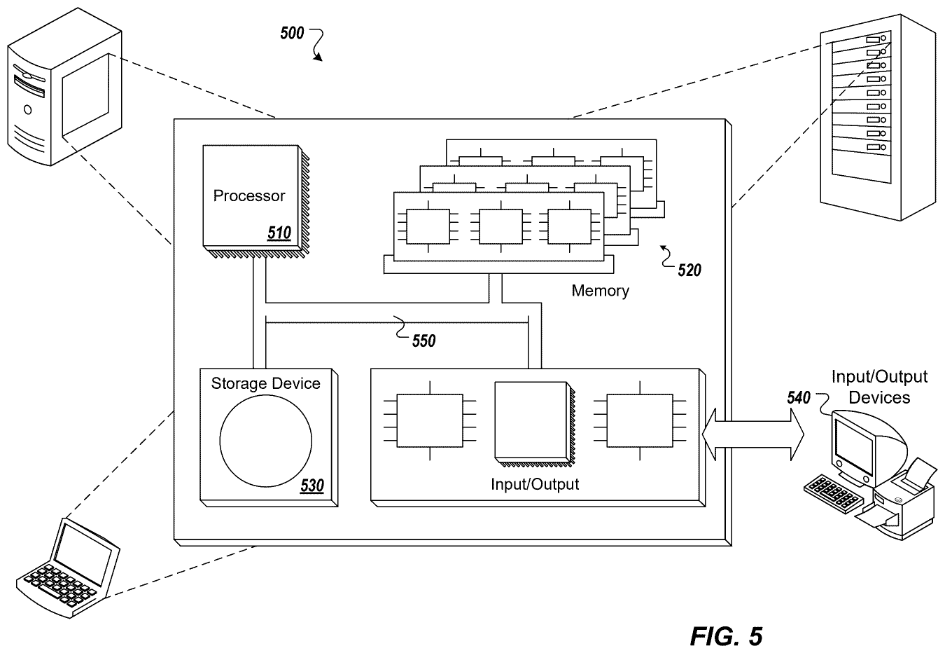

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500.

In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for debugging errors occurring in software, the method being executed by one or more processors and comprising:
receiving a current bug ticket (CBT) comprising bug data descriptive of a bug occurring within a software system;
prompting a large language model (LLM) using a first prompt to return a first embedding representative of at least a portion of the CBT;
determining a set of candidate historical bug tickets (HBTs) using the first embedding and a set of HBT embeddings;
prompting the LLM using a second prompt to return a set of similar HBTs, the second prompt generated using the set of candidate HBTs; and
updating the CBT to identify one or more HBTs in the set of similar HBTs.

2. The method of claim 1, further comprising:
determining a location of a component of the software system associated with the bug; and
updating the CBT to include the location.

3. The method of claim 2, wherein determining a location of a component of the software system associated with the bug comprises searching source code of the software system using an error message of the CBT.

4. The method of claim 2, wherein determining a location of a component of the software system associated with the bug comprises:
prompting the LLM using a third prompt to return a second embedding representative of an error message of the CBT;
determining a set of candidate slices using the second embedding and a set of slice embeddings; and
prompting the LLM using a fourth prompt to return a set of similar slices, the fourth prompt generated using the set of candidate slices.

5. The method of claim 4, wherein each slice comprises a number of lines of the source code.

6. The method of claim 2, wherein the location comprises a uniform resource locator (URL).

7. The method of claim 1, wherein the at least a portion of the CBT comprises a title and a description of the CBT.

8. The method of claim 1, wherein determining a set of candidate HBTs using the first embedding and a set of HBT embeddings comprises:
determining a set of ticket similarity scores by comparing the first embedding to each HBT embedding in the set of HBT embeddings; and
adding a HBT associate with an HBT embedding to the set of candidate HBTs in response to a respective ticket similarity score at least meeting a threshold ticket score.

9. The method of claim 1, wherein the set of HBT embeddings is retrieved from a HBT repository and each HBT embedding in the set of HBT embeddings is generated by the LLM.

10. The method of claim 1, wherein the second prompt is generated using a prompt template that is at least partially populated with HBTs in the set of candidate HBTs to provide context for the LLM in providing the set of similar HBTs.

11. A non-transitory computer-readable storage medium coupled to one or more processors and having instructions stored thereon which, when executed by the one or more processors, cause the one or more processors to perform operations for debugging errors occurring in software, the operations comprising:
receiving a current bug ticket (CBT) comprising bug data descriptive of a bug occurring within a software system;
prompting a large language model (LLM) using a first prompt to return a first embedding representative of at least a portion of the CBT;
determining a set of candidate historical bug tickets (HBTs) using the first embedding and a set of HBT embeddings;
prompting the LLM using a second prompt to return a set of similar HBTs, the second prompt generated using the set of candidate HBTs; and
updating the CBT to identify one or more HBTs in the set of similar HBTs.

12. The non-transitory computer-readable storage medium of claim 11, further comprising:
determining a location of a component of the software system associated with the bug; and
updating the CBT to include the location.

13. The non-transitory computer-readable storage medium of claim 12, wherein determining a location of a component of the software system associated with the bug comprises searching source code of the software system using an error message of the CBT.

14. The non-transitory computer-readable storage medium of claim 12, wherein determining a location of a component of the software system associated with the bug comprises:
prompting the LLM using a third prompt to return a second embedding representative of an error message of the CBT;
determining a set of candidate slices using the second embedding and a set of slice embeddings; and
prompting the LLM using a fourth prompt to return a set of similar slices, the fourth prompt generated using the set of candidate slices.

15. The non-transitory computer-readable storage medium of claim 12, wherein each slice comprises a number of lines of the source code.

16. A system, comprising:
a computing device; and
a computer-readable storage device coupled to the computing device and having instructions stored thereon which, when executed by the computing device, cause the computing device to perform operations for debugging errors occurring in software, the operations comprising:
receiving a current bug ticket (CBT) comprising bug data descriptive of a bug occurring within a software system;
prompting a large language model (LLM) using a first prompt to return a first embedding representative of at least a portion of the CBT;
determining a set of candidate historical bug tickets (HBTs) using the first embedding and a set of HBT embeddings;
prompting the LLM using a second prompt to return a set of similar HBTs, the second prompt generated using the set of candidate HBTs; and
updating the CBT to identify one or more HBTs in the set of similar HBTs.

17. The system of claim 16, further comprising:
determining a location of a component of the software system associated with the bug; and
updating the CBT to include the location.

18. The system of claim 17, wherein determining a location of a component of the software system associated with the bug comprises searching source code of the software system using an error message of the CBT.

19. The system of claim 17, wherein determining a location of a component of the software system associated with the bug comprises:
prompting the LLM using a third prompt to return a second embedding representative of an error message of the CBT;
determining a set of candidate slices using the second embedding and a set of slice embeddings; and
prompting the LLM using a fourth prompt to return a set of similar slices, the fourth prompt generated using the set of candidate slices.

20. The system of claim 17, wherein each slice comprises a number of lines of the source code.
